(19) United States
(12) Patent Application Publication
(10) Pub. No.: US 2026/0223091 A1
(43) Pub. Date: Jul. 30, 2026

(54) METHODS AND APPARATUSES FOR SUPPORTING DYNAMIC SWITCH OF SECONDARY LCH FOR PDU SET TRANSMISSION

(71) Applicant: Lenovo (Beijing) Limited, Beijing (CN)

(72) Inventors: Mingzeng Dai, Shanghai (CN); Xiaoying Xu, Shanghai (CN); Lianhai Wu, Beijing (CN)

(73) Assignee: Lenovo (Beijing) Limited, Beijing (CN)

(21) Appl. No.: 19/146,064

(22) PCT Filed: Jan. 13, 2023
(86) PCT No.: PCT/CN2023/072132

§ 371 Date: Jul. 7, 2025

(51) Int. Cl. H04W 72/0453; H04W 72/566; H04W 76/20; H04W 80/02

(52) U.S. Cl. CPC H04W 72/0453; H04W 72/566; H04W 76/20; H04W 80/02

(57) ABSTRACT

The present application relates to methods and apparatuses for supporting dynamic switch of a secondary logical channel (LCH) for protocol data unit (PDU) set transmission. One embodiment of the present disclosure provides a user equipment (UE) which includes: a transceiver; and a processor coupled with the transceiver and configured to: receive, via the transceiver, a secondary logical channel (LCH) activation indication from a base station (BS) for activating a secondary LCH of a data radio bearer (DRB); and in response to receiving the secondary LCH activation indication from the BS, to: activate the secondary LCH of the DRB; and upon activating the secondary LCH of the DRB, route a packet data convergence protocol (PDCP) protocol data unit (PDU) of a PDU set through the secondary LCH of the DRB.

### TECHNICAL FIELD

The present disclosure relates to wireless communication, and particularly relates to methods and apparatuses for supporting dynamic switch of a secondary logical channel (LCH) for protocol data unit (PDU) set transmission.

### BACKGROUND OF THE INVENTION

A PDU set and PDU set quality of service (QoS) characteristics may be introduced for an extended reality (XR) service, which may include augmented reality (AR) and virtual reality (VR), as well as cloud gaming (CG), and may present a new promising category of connected devices, applications, and services.

There are different types of PDU sets, for example, an important PDU set and an unimportant PDU set. The two types of PDU sets may be transmitted with the same LCH, or with different LCHs. Therefore, it is advantageous to provide solutions for supporting dynamic switch of split LCH for PDU set transmission.

### SUMMARY

One embodiment of the present disclosure provides a user equipment (UE) which includes: a transceiver; and a processor coupled with the transceiver and configured to: receive, via the transceiver, a secondary logical channel (LCH) activation indication from a base station (BS) for activating a secondary LCH of a data radio bearer (DRB); and in response to receiving the secondary LCH activation indication from the BS, to: activate the secondary LCH of the DRB; and upon activating the secondary LCH of the DRB, route a packet data convergence protocol (PDCP) protocol data unit (PDU) of a PDU set through the secondary LCH of the DRB.

In some embodiments, the secondary LCH activation indication is received by a medium access control control element (MAC CE) of the UE or a PDCP control PDU.

In some embodiments, the processor is further configured to: receive a radio resource control (RRC) message including at least one of the following: a second indication indicating whether the DRB is configured with a primary LCH and the secondary LCH; a third indication indicating whether an LCH is a primary LCH or a secondary LCH; an association between a type of a PDU set and an LCH; or a default activation or deactivation status of the secondary LCH.

In some embodiments, the association indicates that a type of PDU set with a second priority level is to be associated with the secondary LCH, or indicates that a type of PDU set with a first priority level and a type of PDU set with a second priority level are to be both associated with a primary LCH and the secondary LCH, respectively.

In some embodiments, the processor is further configured to perform one of the following: in the case that a type of a first PDU set is with a first priority level, route all PDCP PDUs in the first PDU set to the primary LCH; and in the case that a type of a second PDU set is with a second priority level, wherein the second priority level has a lower priority level than the first priority level, route all PDCP PDUs in the second PDU set to the secondary LCH.

In some embodiments, in the case that there are remaining PDCP PDUs of a PDU set with a second priority level to be transmitted with a primary LCH, the processor is further configured to perform one of the following: route all PDCP PDUs of the PDU set with the second priority level to the secondary LCH; route a next PDU set with the second priority level to the secondary LCH; or route the remaining PDCP PDUs of the PDU set with the second priority level to the secondary LCH.

In some embodiments, the processor is further configured to: receive, via the transceiver, a secondary LCH deactivation indication from the BS for deactivating the secondary LCH of the DRB; and in response to receiving the secondary LCH deactivation indication from the BS, to deactivate the secondary LCH of the DRB; and route PDCP PDU of the PDU set through the primary LCH.

In some embodiments, the processor is further configured to: receive, via the transceiver, a secondary LCH deactivation indication from the BS for deactivating the secondary LCH of the DRB, and there are remaining PDCP PDUs of a PDU set with a second priority level to be transmitted with a secondary LCH, in response to receiving the secondary LCH deactivation indication from the BS, to perform one of the following: route all PDCP PDUs of the PDU set with the second priority level to a primary LCH; route a next PDU set with the second priority level to the primary LCH; or route the remaining PDCP PDUs of the PDU set with the second priority level to the primary LCH.

In some embodiments, the secondary LCH activation indication includes an identifier of a reference PDCP PDU or an identifier of a reference PDU set, and the processor is further configured to: activate the secondary LCH upon transmission of the reference PDCP PDU or the reference PDU set.

In some embodiments, the secondary LCH deactivation indication includes an identifier of a reference PDCP PDU or an identifier of a reference PDU set, and the processor is further configured to: deactivate the secondary LCH upon transmission of the reference PDCP PDU or the reference PDU set.

Another embodiment of the present disclosure provides a distributed unit (DU) which includes: a transceiver; and a processor coupled with the transceiver and configured to: determine a secondary LCH activation indication for activating a secondary LCH of a DRB or a secondary tunnel; and transmit, via the transceiver, the secondary LCH activation indication.

In some embodiments, the secondary LCH activation indication is transmitted to a UE, and is carried by a MAC CE or a PDCP control PDU.

In some embodiments, the secondary LCH activation indication is transmitted to a CU, and is included in an F1 signalling or in an F1 user plane protocol.

In some embodiments, the secondary LCH activation indication includes an identifier of a reference PDCP PDU or an identifier of a reference PDU set.

In some embodiments, the processor is further configured to perform one of the following: determine a secondary LCH deactivation indication for deactivating a secondary LCH of the DRB or the secondary tunnel; and transmit, via the transceiver, the secondary LCH deactivation indication.

Still another embodiment of the present disclosure provides a central unit (CU) which includes: a transceiver; and a processor coupled with the transceiver and configured to: activate a secondary tunnel; and upon activating the secondary tunnel, route a PDCU PDU of a PDU set through the secondary tunnel.

In some embodiments, the processor is further configured to perform one of the following: in the case that a type of a first PDU set is with a first priority level, route all PDCP PDUs in the first PDU set to the primary tunnel; and in the case that a type of a second PDU set is with a second priority level, route all PDCP PDUs in the second PDU set to the secondary tunnel, wherein the second priority level has a lower priority level than the first priority level.

In some embodiments, in the case that there are remaining PDCP PDUs of a PDU set with a second priority level to be transmitted with a primary tunnel, the processor is further configured to perform one of the following: route all PDCP PDUs of the PDU set with the second priority level to the secondary tunnel; route a next PDU set with the second priority level to the secondary tunnel; or route the remaining PDCP PDUs of the PDU set with the second priority level to the secondary tunnel.

In some embodiments, the processor is further configured to: deactivate the secondary tunnel; and in response to deactivating the secondary tunnel, to deactivate the secondary tunnel; and route a PDCP PDU of the PDU set through the primary tunnel.

In some embodiments, the processor is further configured to: deactivate the secondary tunnel, and in the case that there are remaining PDCP PDUs of a PDU set with a second priority level to be transmitted with the secondary tunnel; upon deactivating the secondary tunnel, to perform one of the following: route all PDCP PDUs of the PDU set with the second priority level to a primary tunnel; route a next PDU set with the second priority level to the primary tunnel; or route the remaining PDCP PDUs of the PDU set with the second priority level to the primary tunnel.

In some embodiments, an identifier of a reference PDCP PDU or an identifier of a reference PDU set is determined, and the processor is further configured to: activate the secondary tunnel upon transmission of the reference PDCP PDU or the reference PDU set.

In some embodiments, an identifier of a reference PDCP PDU or an identifier of a reference PDU set is determined, and the processor is further configured to: deactivate the secondary tunnel upon transmission of the reference PDCP PDU or the reference PDU set.

Still another embodiment of the present disclosure provides a method performed by a UE which includes: receiving a secondary LCH activation indication from a BS for activating a secondary LCH of a DRB; and in response to receiving the secondary LCH activation indication, activating the secondary LCH of the DRB; and upon activating the secondary LCH of the DRB, routing a PDCU PDU of a PDU set through the secondary LCH of the DRB.

Still another embodiment of the present disclosure provides a method performed by a DU which includes: determining a secondary LCH activation indication for activating a secondary LCH of a DRB or a secondary tunnel; and transmitting the secondary LCH activation indication.

Still another embodiment of the present disclosure provides a method performed by a CU which includes: activating a secondary tunnel; and upon activating the secondary tunnel, routing a PDCU PDU of a PDU set through the secondary tunnel.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system according to some embodiments of the present disclosure.

FIG. 2 illustrates a DRB according to some embodiments of the present disclosure.

FIG. 3 illustrates a flow chart for supporting dynamic switch of a secondary LCH for PDU set transmission according to some embodiments of the present disclosure.

FIG. 4 illustrates a secondary LCH activation indication MAC CE or a secondary LCH deactivation indication MAC CE according to some embodiments of the present disclosure.

FIG. 5 illustrates transmission of PDU sets of a DRB according to some embodiments of the present disclosure.

FIG. 6 illustrates a flow chart for supporting dynamic switch of a secondary LCH for PDU set transmission according to some embodiments of the present disclosure.

FIG. 7 illustrates a flow chart for supporting dynamic switch of a secondary LCH or a secondary tunnel for PDU set transmission according to some embodiments of the present disclosure.

FIG. 8 illustrates a flow chart for supporting dynamic switch of a secondary LCH or a secondary tunnel for PDU set transmission according to some embodiments of the present disclosure.

FIG. 9 illustrates a method performed by a UE according to some embodiments of the present disclosure.

FIG. 10 illustrates a method performed by a DU according to some embodiments of the present disclosure.

FIG. 11 illustrates a method performed by a CU according to some embodiments of the present disclosure.

FIG. 12 illustrates a simplified block diagram of an apparatus according to some embodiments of the present disclosure.

### DETAILED DESCRIPTION

The detailed description of the appended drawings is intended as a description of the currently preferred embodiments of the present invention, and is not intended to represent the only from in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as a cellular telephone network, a time division multiple access (TDMA)-based network, a code division multiple access (CDMA)-based network, an orthogonal frequency division multiple access (OFDMA)-based network, a LTE network, a 3^{rd} generation partnership project (3GPP)-based network, LTE, LTE-Advanced (LTE-A), 3GPP 4G, 3GPP 5G NR, 3GPP Release 16 and onwards, a satellite communications network, a high altitude platform network, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

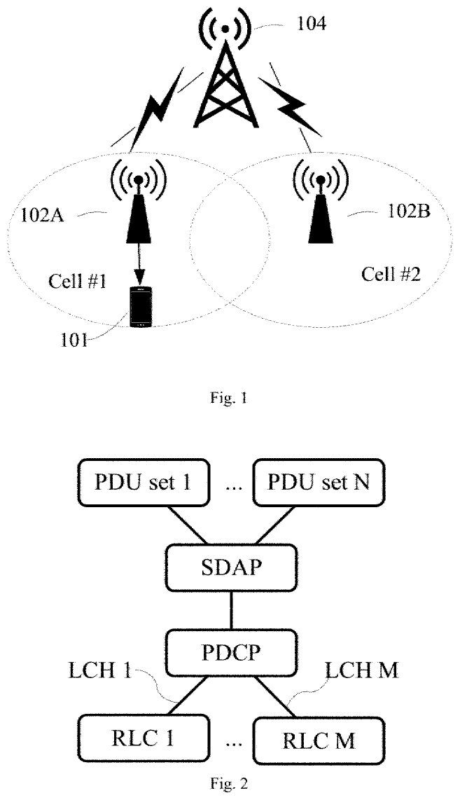

FIG. 1 illustrates a schematic diagram of a wireless communication system according to some embodiments of the present disclosure.

The wireless communication system in FIG. 1 includes a CU (e.g., CU 104), a UE (e.g., UE 101), and some DUs (e.g., DU 102A and DU 102B). The DU 102A and DU 102B are controlled by CU 104, and provides services for UEs within cell #1 and cell #2 respectively. Even though there are only one UE and two DUs in FIG. 1, persons skilled in the art will recognize that any number of UEs and DUs may be included in the wireless communication system.

UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, modems), or the like. According to an embodiment of the present disclosure, UE 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, UE101 includes wearable devices, such as smart watches, fitness bands, optical head-mounted displays, or the like. Moreover, UE 101 may be referred to as subscriber units, mobiles, mobile stations, users, terminals, mobile terminals, wireless terminals, fixed terminals, subscriber stations, user terminals, a device, or by other terminology used in the art.

The DU 102A and DU 102B may be distributed over a geographic region. In certain embodiments, a DU may also be referred to as an access node, an access point, an access terminal, a base, a base station, a macro cell, a node-B, an enhanced node B (eNB), a gNB, a home node-B, a relay node, a device, or by any other terminology used in the art. The DU 102A and DU 102B may be generally a part of a radio access network that may include one or more controllers communicably coupled to one or more corresponding base stations.

The CU 104 may be distributed over a geographic region and may control the DU 102A and DU 102B. In certain embodiments, a CU may also be referred to as, an access node, an access point, an access terminal, a base, a base station, a macro cell, a node-B, an enhanced node B (eNB), a gNB, a home node-B, a relay node, a device, or by any other terminology used in the art.

The wireless communication system is compliant with any type of network that is capable of sending and receiving wireless communication signals. For example, the wireless communication system is compliant with a wireless communication network, a cellular telephone network, a TDMA-based network, a CDMA-based network, an OFDMA-based network, a long-term evolution (LTE) network, a 3GPP-based network, 3GPP 5G network, a satellite communications network, a high altitude platform network, and/or other communications networks.

In one implementation, the wireless communication system is compliant with the NR of the 3GPP protocol, wherein the transmission may be performed using an OFDM modulation scheme. More generally, the wireless communication system may implement some other open or proprietary communication protocol, for example, WiMAX, among other protocols.

In other embodiments, the transmission may be performed using other communication protocols, such as the IEEE 802.11 family of wireless communication protocols. Further, in some embodiments the transmission may be performed over licensed spectrum, while in other embodiments the transmission may be performed over unlicensed spectrum. The present disclosure is not intended to be limited to the implementation of any particular wireless communication system architecture or protocol. In another embodiment, the transmission may be performed using the 3GPP 5G protocols.

The PDU sets may have different priority levels, such a PDU set with a higher priority level, or with lower priority level; the PDU sets may have different types, as an important PDU set, or an unimportant PDU set. Hereinafter in the present disclosure, PDU sets with different priority levels are used for describing the solutions, and persons skilled in the art may understand that PDU sets with different priority levels may include an important PDU set, or an unimportant PDU set; or PDU set type 1, PDU set type 2, etc.

In some embodiments, all PDUs in a PDU set are needed by the application layer to use the corresponding unit of information. In other embodiments, the application layer may still recover parts all or of the information unit, when some PDUs in a PDU set are missing.

A PDU set may be composed of one or more PDUs carrying the payload of one unit of information generated at the application level (e.g., a frame or video slice for XRM Services). In some embodiments, all PDUs in a PDU set are needed by the application layer to use the corresponding unit of information. In some other embodiments, the application layer may still recover all of the information unit, when some PDUs in the PDU set are missing.

PDU sets may carry different content, e.g., I frames, B frames, or P frames, slices or tiles within an I frame, a B frame, or a P frame, etc. The present disclosure proposes to handle different PDU sets with different priority levels differently, for example, by treating PDUs (i.e., packets) belonging to a PDU set with lower priority level (i.e., a less important PDU set) differently to reduce the resource wasting.

In order to support reordering function, different types of PDU set may be mapped to one DRB. On the other hand, to different importance handling for different types of PDU set, one DRB may be configured with at least two RLC entities, whose corresponding LCHs may have different priority levels. Then the DRB is spited into the at least two corresponding LCHs.

FIG. 2 illustrates a DRB according to some embodiments of the present disclosure.

In FIG. 2, there are N PDU sets, e.g., PDU set 1, PDU set 2, . . . , PDU set N, where N is an integer equal to or larger than 2, are mapped to one DRB. PDU set 1 may have a priority level value 1; PDU set 2 may have a priority level value 2; . . . , PDU set N may have a priority level value N.

The DRB may be configured with M RLC entities, e.g., RLC 1, RLC 2, . . . , RLC M, each corresponding to one LCH, where M is an integer equal to or larger than 2. RLC 1 may have a priority level value 1; RLC 2 may have a priority level value 2; . . . , RLC M may have a priority level value M. Correspondingly, LCH 1 may have a priority level value 1; LCH 2 may have a priority level value 2; . . . , LCH M may have a priority level value M.

In some embodiments, M may equal to N, and each RLC entity or each logical channel may correspond to one type of PDU set based on the corresponding priority level. In some other embodiments, M may not equal to N, each RLC entity or each logical channel may correspond to one or more types of PDU sets, or vice versa.

In some embodiments, both the value of M and the value of N are two. In this case, the PDU set with a higher priority level may also be referred to as an important PDU set or PDU set type 1, the PDU set with a lower priority level may also be referred to as an unimportant PDU set or PDU set type 2. The LCH with a higher priority level may also be referred to as a primary LCH or a primary leg, the LCH with a lower priority level may also be referred to as a secondary LCH or a secondary leg.

The DRB may have a common service data adaption protocol (SDAP) layer and a common packet data convergence protocol (PDCP) layer. The DRB may be served by one cell or one cell group in a single DU or in a single gNB, e.g., in DU 102A as shown in FIG. 1.

However, the transmission of different PDU sets with different priority levels may have some issues. One issue may be that a PDU set with a lower priority level may be blocked or delayed even when network is not congested. The PDU set with a higher priority level may use the an LCH with a higher priority level, e.g., a primary LCH, and may always be transmitted before the PDU sets with lower priority level with an LCH with lower priority level, e.g., a secondary LCH. In some embodiments, a later arrived important PDU set on the primary LCH may always be transmitted before the earlier arrived unimportant PDU set on the secondary LCH, which may render unnecessarily delay transmission of the earlier arrived unimportant PDU set, for example, a P frame. In other words, some transmissions of the unimportant PDU set with a secondary LCH may be blocked. Accordingly, the user experience may be impacted.

The present disclosure proposes some solutions for solving this issue. Hereinafter in the present disclosure, two LCHs (or two legs, corresponding to two RLC entities) and two types of PDU sets are used for describing the solutions, and persons skilled in the art are aware that the solutions in the present disclosure may also apply to other numbers of LCHs or other numbers of types of PDU sets.

More specifically, the present disclosure introduces an indication that may activate or deactivate the secondary LCH of the DRB. The indication may activate or deactivate the secondary leg between the UE and the DU or the secondary F1-U tunnel between the CU and DU. This indication may be referred to as a secondary LCH activation indication, a secondary LCH deactivation indication, a split LCH activation indication, a split LCH deactivation indication, or the like. Hereinafter in the present disclosure, the expression “a secondary LCH activation indication” and “a secondary LCH deactivation indication” are used.

When network congestion happens, the secondary LCH may be activated, and then the PDU sets with higher priority level, e.g., PDU sets of I frames, will be transmitted by the primary LCH while the PDU sets with lower priority level, e.g., PDU sets of P frames will be transmitted by the secondary LCH. The PDU sets of P frames may be discarded due to lack of radio resource and logical channel prioritization (LCP) handling. When network congestion is alleviated, the secondary LCH is deactivated; both PDU sets of I-frames and P-frames may be transmitted by the primary LCH.

### Solution 1:

Solution 1 focuses on UL data transmission between a UE and a BS. When UL congestion happens, the BS may send a secondary LCH activation indication to the UE that may indicate the UE to activate the secondary LCH and split important PDU sets and unimportant PDU sets to different RLC entities or LCHs. Upon receiving the secondary LCH activation indication, the UE may activate the secondary LCHs, and the PDCP layer of the UE may deliver the important PDU sets and unimportant PDU sets to the corresponding RLC entity or LCH. When UL congestion is alleviated, the BS may send a secondary LCH deactivation indication to the UE, and the UE may deactivate the secondary LCH and deliver all PDU sets to the primary RLC entity or LCH. In some other cases, the BS may indicate the UE to activate or deactivate more LCHs or more RLC entities, and the UE may deliver the PDU sets to the corresponding RLC entity or LCH in a similar fashion.

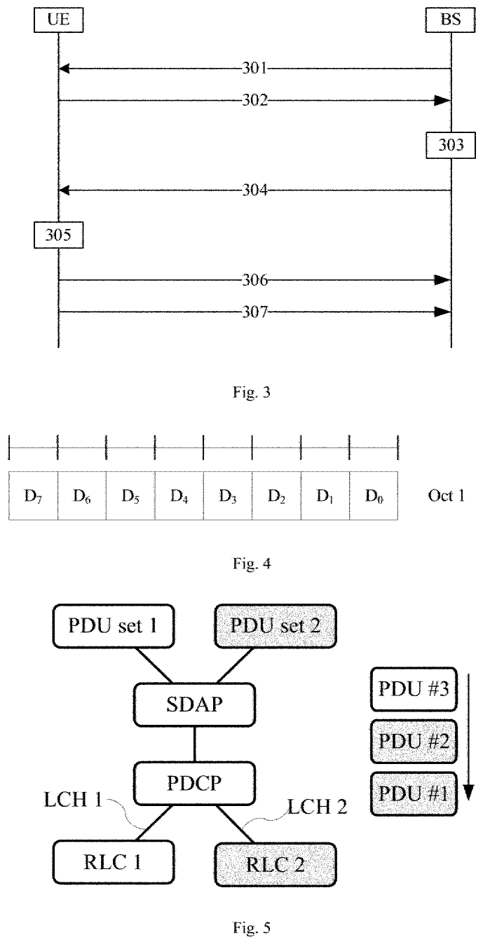

FIG. 3 illustrates a flow chart for supporting dynamic switch of a secondary LCH for PDU set transmission according to some embodiments of the present disclosure.

FIG. 3 relates to UL data transmission between a UE and a BS. The UE may be UE 101 as shown in FIG. 1, and the BS may be a BS in any wireless communication system.

In operation 301, the BS may transmit a message to the UE, e.g., an RRC message such as an RRC configuration message, which may configure a DRB with multiple LCHs. The configuration may include the following:
An indication indicating whether one or more RLC entities, or one or more LCHs are configured for the DRB; for example, as shown in FIG. 2, whether the DRB is configured with one or more of RLC entity 1, RLC entity 2, . . . , RLC entity N, and whether the DRB is configured with one or more of LCH 1, LCH 2, . . . , LCH M.
An indication indicating a priority level of an LCH, for example, as shown in FIG. 2, this indication may indicate the priority level of LCH 1 is 1, the priority level of LCH 2 is 2, the priority level of LCH M is M, etc.
In some embodiments, the DRB may be configured with two LCHs, the LCH with a higher priority level may be referred to as a primary LCH, or primary leg, and the LCH with a lower priority level may be referred to as a secondary LCH, or secondary leg. In this case, the indication may be a primary LCH (or primary leg) indication, which indicates an RLC entity or LCH is a primary leg, or the LCH is a primary LCH; or a secondary LCH (or secondary leg) indication, which indicates an RLC entity or LCH is a secondary leg, or the LCH is a secondary LCH.
An association between a type of a PDU set and an LCH (or a leg, a RLC entity). For example, one association may indicate that the LCH (or the leg, the RLC entity) with a highest priority level is used to transmit all types of PDU sets when other LCHs are not activated. Another association may indicate that the LCH (or the leg, the RLC entity) with a highest priority level is used to transmit a type of PDU set with the highest priority level when other LCHs are activated. Still another association may indicate that the LCH (or the leg, the RLC entity) with a priority level is used to transmit a type of PDU set with the same priority level when the LCH with the corresponding priority level is activated. For example, an LCH with the priority level of 5 is used to transmit a PDU set with the priority level of 5.
In the case that there are two types of PDU sets (i.e., important and unimportant PDU sets) and two LCHs (i.e., primary and secondary LCHs), an example of the association is as follows:
   when the secondary LCH is not activated, the primary LCH may be used to transmit both the important PDU set and the unimportant PDU set; and
   when the secondary LCH is activated, the primary LCH is used to transmit only the important PDU set and the secondary LCH is used to transmit the unimportant PDU set.
Another example of the association is as follows:
   when the primary LCH is not activated, the secondary LCH may be used to transmit both the important PDU set and the unimportant PDU set; and
   when the primary LCH is activated, the primary LCH is used to transmit only the important PDU set and the secondary LCH is used to transmit the unimportant PDU set.
A default activation or deactivation status of an LCH which is not with the highest priority level. For example, the LCHs with other priority levels except the highest priority level is initially activated or deactivated by default.
In the case that there are two LCHs, this default activation or deactivation may be an initial activation or deactivation status of the secondary LCH, in other words, whether the secondary LCH is activated or deactivated initially is explicitly or implicitly indicated. In some embodiments, the secondary LCH may be also activated or deactivated by default. For another example, the LCH with priority levels except the lowest priority levels may be initially activated or deactivated by default.

An example of the configuration may be included in an information element (IE), e.g., the PDCP-Config IE, in the RRC configuration message as follows:

| PDCP-Config | Value range |
|---|---|
| More RLC/LCHs indication | BOOLEAN (Yes) |
| Primary Leg | LCID 1 |
| PDU set type | PDU set type 1 (important PDU set) |
| Secondary Leg | LCID2 |
| PDU set type | PDU set type 2 (unimportant PDU set) |
| Initial activation status | BOOLEAN (Yes) |

Hereinafter in the present disclosure, two LCHs (or two legs, two RLC entities) and two types of PDU sets are used for describing the solutions, and persons skilled in the art are aware that other numbers of LCHs or other numbers of types of PDU sets may also be achieved by the solution in a similar fashion.

In operation 302, the UE may perform UL transmission with the BS. More specifically, the secondary LCH is not activated, and both types of PDU sets are transmitted with the primary LCHs. In another example, if the primary LCH is not activated, both types of PDU sets are transmitted with the secondary LCHs.

In operation 303, the BS may determine that there is UL congestion, and may determine to activate the secondary LCH. In another example, the BS may determine to activate the primary LCH in the case that the secondary LCH is activated by default.

In operation 304, the BS may transmit an indication, for example, a secondary LCH activation indication, to the UE, which may indicate the UE to activate the secondary LCH. In another example, in the case that the secondary LCH is activated by default, the BS may transmit an indication, e.g. a primary LCH activation indication, to the UE, which may indicate the UE to activate the primary LCH.

In some embodiments, the indication may be a MAC CE, for example, a secondary LCH activation MAC CE (or a split LCH activation indication MAC CE). In another example, a primary LCH activation MAC CE is used for activating the primary LCH.

FIG. 4 illustrates a secondary LCH activation indication MAC CE or a secondary LCH deactivation indication MAC CE according to some embodiments of the present disclosure. The primary LCH activation indication is designed in the similar way.

The secondary LCH activation indication MAC CE or secondary LCH deactivation indication MAC CE may be an octet identified by a MAC subheader with a logical channel identifier (LCID). It may have a fixed size and may consist of a single octet containing eight D-fields (taking 8 secondary LCHs as an example). The secondary LCH activation indication or secondary LCH deactivation indication MAC CE may be defined for a MAC entity.

For one field, such as Di, this field may indicate the activation or deactivation status of the secondary LCH (or leg) i, where i may be an integer ranging from 0 to 7, and i is the ascending (or descending) order in the RRC configuration. The value of “1” of a Di field may indicate that the secondary LCH i shall be activated. The value of “0” of a Di field may indicate that the secondary LCH i shall be deactivated.

The secondary LCH activation indication or secondary LCH deactivation indication MAC CE may also include an identifier of a reference PDCP PDU (denoted as I_{PDCP} for simplicity) or an identifier of a reference PDU set (denoted as I_{PDUset} for simplicity) that indicates the UE may activate the secondary LCH when performing the transmission of the PDCP PDU with the identifier of I_{PDCP}, or the PDU set with the identifier of I_{PDUset}. The identifier of a reference PDCP may also be the count value or sequence number of a reference PDCP PDU, or the like. The identifier of a reference PDU set may also be the sequence number of a PDU set.

In some embodiments, the secondary LCH activation indication or secondary LCH deactivation indication may be carried by a PDCP control PDU.

Referring back to FIG. 3, in operation 305, the UE may receive the secondary LCH activation indication. The MAC layer of the UE may forward the secondary LCH activation indication to the PDCP layer. The PDCP layer may route the PDCP PDU based on the association between a type of a PDU set and an LCH, that is, based on the priority levels of different PDU set types and based on the priority levels of different LCHs (or different legs, different RLC entities).

Taking two types of PDU sets (e.g., PDU set type 1 and PDU set type 2, or important PDU set and unimportant PDU set) as an example, and two LCHs (e.g., primary LCH and secondary LCH) as an example, in the case that the secondary LCH is as activated for the DRB, for a PDU set type 1, or for an important PDU set, the PDCP PDU in the PDU set is routed to the primary LCH; for a PDU set type 2, or for an unimportant PDU set, the PDCP PDU in the PDU set is routed to the secondary LCH.

An example in the 3GPP documents may be as follows:

- if the split LCHs is activated for the DRB

| | |
|---|---|
| - | if the PDU set type of the PDCP PDU is same as |

PDUSetType1; or the PDU set type of PDCP PDU is
an important PDU set:

| | | |
|---|---|---|
| | - | submit the PDCP PDU to the primary |
| RLC entity; | | |

| | |
|---|---|
| - | else if the PDU set type of the PDCP PDU is |

same as PDUSetType2; or the PDU set type of PDCP
PDU is an unimportant PDU set::
- submit the PDCP PDU to the secondary RLC

entity;

In operation 306, the UE may perform the transmission of PDU set type 1 through the primary LCH, and in operation 307, the UE may perform the transmission of PDU set type 2 through the secondary LCH.

In some embodiments, when the UE receives the secondary LCH activation indication, some PDCP PDUs of the PDU set type 2 (or an unimportant PDU set) may have been transmitted by the PDCP layer through the primary LCH (or the primary leg), and there are still some remaining PDCP PDUs of the PDU set type 2 to be transmitted. In this case, the present disclosure proposes the following options A1-A3 for transmitting the PDU set type 2.
Option A1: the PDCP layer may route all the PDCP PDUs of the PDU set type 2 to the secondary LCH, whereby it should be noted that all the PDCP PDUs of the PDU set type 2 include the PDCP PDUs that have already been transmitted.
Option A2: the PDCP layer may continue transmitting the remaining PDCP PDUs of the PDU set through the primary LCH and may start to route the next PDU set type 2 to the secondary LCH.
Option A3: the PDCP layer may route the remaining PDCP PDUs of the PDU set type 2 to the secondary LCH.

In some other cases, the secondary LCH activation indication may include an identifier of a reference PDCP PDU (e.g., I_{PDCP}, the count value or sequence number of the reference PDCP PDU) or an identifier of a reference PDU set (e.g., I_{PDUset}). In this case, the UE may activate the secondary LCH (or the secondary leg) when the UE is about to perform the transmission of the reference PDCP PDU with the identifier of I_{PDCP}, or the reference PDU set with the identifier of I_{PDUset}.

FIG. 5 illustrates transmission of PDU sets of a DRB according to some embodiments of the present disclosure.

In FIG. 5, PDU set 1 may be with a higher priority level, e.g., an important PDU set or a PDU set type 1, and PDU set 1 may include one PDCP PDU, e.g., PDCP PDU #3. PDU set 2 may be with lower priority level, e.g., an unimportant PDU set or a PDU set type 2, and PDU set 2 may include two PDCP PDUs, e.g., PDCP PDU #1 and PDCP PDU #2.

In the case that secondary LCH is not activated, all three PDCP PDUs, i.e., PDCP PDU #1, PDCP PDU #2, and PDCP PDU #3, are transmitted by the primary LCH. When the UE receives the secondary LCH activation indication, which does not indicate an identifier of a reference PDCP or a reference PDU set, PDU #1 of PDU set 2 has been successfully transmitted, and PDCP PDU #2 of PDU set 2 has not been transmitted.

Regarding the transmission of the PDCP PDUs of PDU set 2, based on the above options A1-A3, the PDCP layer may perform the following options a1-a3:
Option a1: the PDCP layer may route PDCP PDU #1 and PDCP PDU #2 to the secondary LCH even though the PDCP PDU #1 has been successfully transmitted to the primary LCH.
Option a2: the PDCP layer may continue to transmit PDCP PDU #2 to the primary LCH and may start to transmit the PDCP PDU of the next PDCP PDU set of PDU set type 2 to the secondary LCH.
Option a3: the PDCP layer may route the remaining PDCP PDU #2 of the PDU set to the secondary LCH.

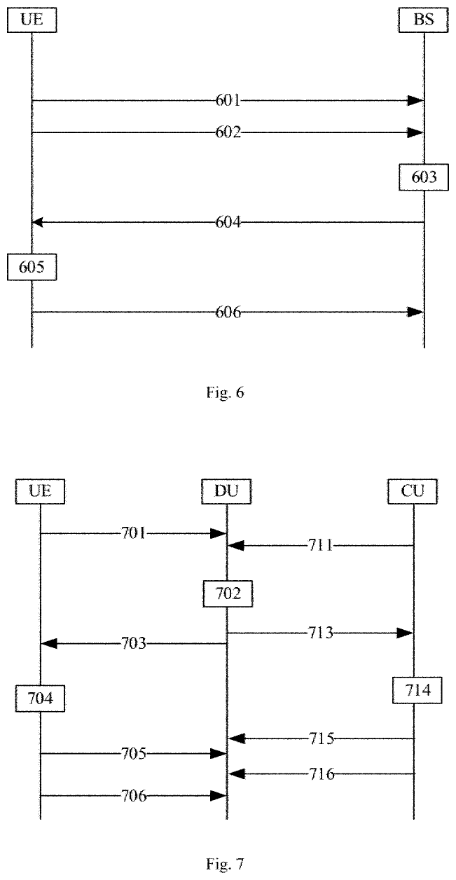

FIG. 6 illustrates a flow chart for supporting dynamic switch of a secondary LCH for PDU set transmission according to some embodiments of the present disclosure.

In operation 601, the UE may perform the transmission of PDU set type 1 with the primary LCH, and in operation 602, the UE may perform the transmission of PDU set type 2 with the secondary LCH.

In operation 603, the BS may determine that the UL congestion is alleviated, and may determine to deactivate the secondary LCH. In another example, it is also possible that the BS may determine to deactivate the primary LCH, for which case the similar method listed below can be reused.

In operation 604, the BS may transmit an indication, e.g., a secondary LCH deactivation indication, or a split LCH deactivation indication, to the UE, e.g. via a MAC CE.

In operation 605, the UE may receive the secondary LCH deactivation indication MAC CE. The MAC layer of the UE may forward the secondary LCH deactivation indication to the PDCP layer. The PDCP layer may route all the PDCP PDUs to the primary LCH.

In some embodiments, when the UE receives the secondary LCH deactivation indication, some PDCP PDUs of the PDU set type 2 (or an unimportant PDU set) may have been transmitted by the PDCP layer with the secondary LCH (or the secondary leg), and there are still some remaining PDCP PDUs of the PDU set type 2 to be transmitted. In this case, the present disclosure proposes the following options B1-B3 for transmitting the PDU set type 2.
Option B1: the PDCP layer may route all the PDCP PDUs of the PDU set type 2 via the primary LCH, whereby it should be noted that all the PDCP PDUs of the PDU set type 2 include the PDCP PDUs that have already been transmitted.
Option B2: the PDCP layer may continue transmitting the remaining PDCP PDUs of the PDU set type 2 via the secondary LCH and may start to route the next PDU set to the primary LCH. In this case, the secondary LCH may be deactivated after the transmission of the PDU set type 2.
Option B3: the PDCP layer may route the remaining PDCP PDUs of the PDU set type 2 to the primary LCH.

In some other cases, the secondary LCH deactivation indication may include an identifier of a reference PDCP PDU (denoted as I_{PDCP} for simplicity) or an identifier of a reference PDU set (denoted as I_{PDUset} for simplicity) that indicates the UE may deactivate the secondary LCH when performing the transmission of the PDCP with the identifier of I_{PDCP}, or the PDU set with the identifier of I_{PDUset}. The identifier of a reference PDCP PDU may be the count value or sequence number of the reference PDCP PDU, or the like. The identifier of a reference PDCP set may be the sequence number of the reference PDCP set.

Referring back to FIG. 5, in the case that the secondary LCH is activated, PDCP PDU #1 and PDCP PDU #2 of PDU set 2 are transmitted by the secondary LCH, and PDCP PDU #1 is transmitted by the primary LCH. When the UE receives the secondary LCH deactivation indication, which does not indicate an identifier of a reference PDCP or a reference PDU set, PDU #1 of PDU set 2 has been successfully transmitted, and PDU #2 of PDU set 2 has not been transmitted.

Regarding the transmission of the PDCP PDUs of PDU set 2, based on the above options B1-B3, the PDCP layer may perform the following options b1-b3:
Option b1: the PDCP layer may route PDCP PDU #1 and PDCP PDU #2 to the primary LCH even though PDCP PDU #1 has been successfully transmitted to the secondary LCH.
Option b2: the PDCP layer may continue to transmit PDCP PDU #2 to the secondary LCH and may start to transmit the PDCP PDU of the next PDCP PDU set to the primary LCH. In this case, the secondary LCH may be deactivated after the transmission of PDCP PDU #2.
Option b3: the PDCP layer may route the remaining PDCP PDU #2 of the PDU set 2 to the primary LCH.

In operation 606, the UE may perform the transmission of all PDCP PDUs of all PDU sets with the primary LCH.

### Solution 2:

In solution 2, F1 signalling is introduced to support the secondary LCH activation or deactivation between CU and DU of a BS.

FIG. 7 illustrates a flow chart for supporting dynamic switch of a secondary LCH or a secondary tunnel for PDU set transmission according to some embodiments of the present disclosure.

FIG. 7 relates to UL data transmission between a UE and a DU, and DL data transmission between a CU and a DU. The UE may be UE 101 as shown in FIG. 1, the DU may be DU 102A in FIG. 1, and the CU may be CU 104 in FIG. 1.

In FIG. 7, the secondary LCH or the secondary tunnel is not activated initially. In another example, it is also possible the primary LCH or the primary tunnel is not activated while the secondary LCH or the second tunnel is activated initially.

The operations between the UE and the DU (for example, a gNB-DU), i.e., operations 701-706, are similar to operations 302 to 307 respectively in FIG. 3, and the details are omitted here. It should be noted that the operations between UE and DU (i.e., operations 701-706) and operations between DU and CU (i.e., operations 702 and 711-716) may be independent.

In operation 711, the DU and the CU (for example, a gNB-CU) may perform both the transmission of PDU set type 1 and PDU set type 2 by the primary tunnel (e.g., an F1-U tunnel) between the DU and the CU.

In operation 702, the DU may determine to activate the secondary F1-U tunnel.

In operation 713, the DU may transmit an indication, for example, a secondary LCH activation indication, a split LCH activation indication, or a secondary tunnel activation indication, to the CU, which may indicate the CU to activate the secondary tunnel (e.g., a secondary F1-U tunnel). The secondary LCH activation indication may be carried by an F1-AP message or on a F1 user plane protocol.

In some other cases, the secondary LCH activation indication may be included in a F1-U frame, e.g., the DL DATA DELIVERY STATUS frame over the primary F1-U tunnel, or in a message, e.g., an F1 AP UE Context Modification Required message.

The secondary LCH activation indication may further include an identifier of a reference PDCP PDU (denoted as I_{PD}CP for simplicity) or an identifier of a reference PDU set (denoted as I_{PDUset} for simplicity) that indicates the CU may activate the secondary tunnel when performing the transmission of the PDCP PDU with the identifier of I_{PDCP}, or the PDU set with the identifier of I_{PDUset}.

In operation 714, the CU may perform PDCP routing for different PDU sets for DL data transmission. More specifically, the CU may route the DL PDCP PDU based on the association between a type of a PDU set and an F1-U tunnel.

Taking two types of PDU sets (e.g., PDU set type 1 and PDU set type 2, or important PDU set and unimportant PDU set) as an example, and two F1-U tunnels as an example, in the case that the secondary tunnel is activated for the DRB, for a PDU set type 1 (or an important PDU set), the PDCP PDU in the PDU set type 1 is routed to the primary F1-U tunnel; for a PDU set type 2 (or an unimportant PDU set), the PDCP PDU in the PDU set type 2 is routed to the secondary F1-U tunnel.

In some embodiments, when the CU receives the indication that activates the secondary tunnel, some PDCP PDUs of the PDU set type 2 (or an unimportant PDU set) may have been transmitted with the primary tunnel, and there are still some remaining PDCP PDUs of the PDU set type 2 to be transmitted. In this case, the present disclosure proposes the following options C1-C3 for transmitting the PDU set type 2.
Option C1: the CU may route all the PDCP PDUs of the PDU set type 2 via the secondary tunnel, whereby it should be noted that all the PDCP PDUs of the PDU set type 2 include the PDCP PDUs that have already been transmitted.
Option C2: the CU may continue transmitting the remaining PDCP PDUs of the PDU set type 2 via the primary tunnel and may start to route the next PDU set to the secondary tunnel.
Option C3: the CU may route the remaining PDCP PDUs of the PDU set type 2 to the secondary tunnel.

In operation 715, the CU may perform the transmission of PDU set type 1 with the primary tunnel, and in operation 716, the CU may perform the transmission of PDU set type 2 with the secondary tunnel.

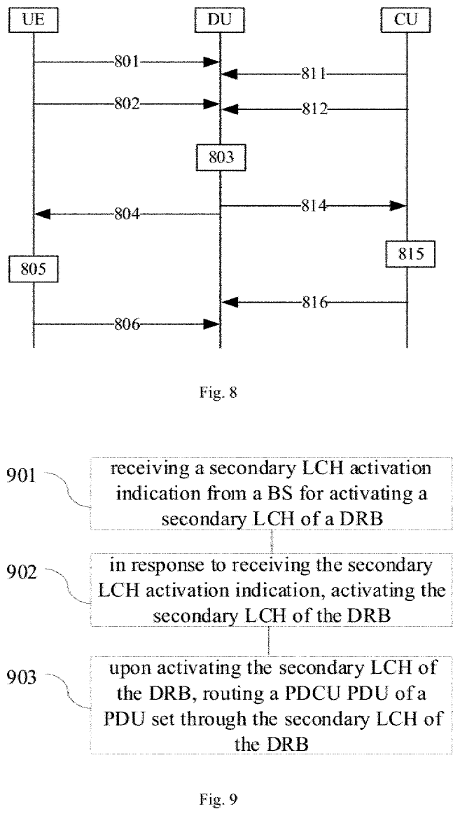

FIG. 8 illustrates a flow chart for supporting dynamic switch of a secondary LCH or a secondary tunnel for PDU set transmission according to some embodiments of the present disclosure.

In FIG. 8, the secondary LCH or the secondary tunnel is activated initially.

The operations between the UE and the DU (for example, a gNB-DU), i.e., operations 801-806, are similar to operations 601 to 606 in FIG. 6 respectively, and the details are omitted here. It should be noted that operations between UE and DU (i.e., operations 801-806) and operations between DU and CU (i.e., operations 803 and 811-816) may be independent.

In operation 811, the DU and the CU (for example, a gNB-CU) may perform the DL transmission of PDU set type 1 by the primary tunnel (e.g., an F1-U tunnel) between the DU and the CU.

In operation 812, the DU and the CU may perform the DL transmission of PDU set type 2 by the secondary tunnel (e.g., an F1-U tunnel) between the DU and the CU.

In operation 803, the DU may determine to deactivate the secondary F1-U tunnel.

In operation 814, the DU may transmit an indication, for example, a secondary LCH deactivation indication, a split LCH deactivation indication, or a secondary tunnel deactivation indication, to the CU, which may indicate the CU to deactivate the secondary tunnel (e.g., a secondary F1-U tunnel). The secondary LCH deactivation indication may be carried by an F1-AP message or on a F1 user plane protocol.

In some other cases, the secondary LCH deactivation indication may be included in a F1-U frame, e.g., the DL DATA DELIVERY STATUS frame over the primary F1-U tunnel, or in a message, e.g., an F1 AP UE Context Modification Required message.

The secondary LCH deactivation indication may further include an identifier of a reference PDCP PDU (denoted as I_{PDCP} for simplicity) or an identifier of a reference PDU set (denoted as I_{PDUset} for simplicity) that indicates the CU may deactivate the secondary tunnel when performing the transmission of the PDCP PDU with the identifier of I_{PDCP}, or the PDU set with the identifier of I_{PDUset}.

In operation 815, the CU may performs PDCP routing for different PDU sets for DL data transmission. More specifically, the CU may route all DL PDCP PDUs to the primary tunnel.

In some embodiments, when the CU receives the indication that deactivates the secondary tunnel, some PDCP PDUs of the PDU set type 2 (or an unimportant PDU set) may have been transmitted with the secondary tunnel, and there are still some remaining PDCP PDUs of the PDU set type 2 to be transmitted. In this case, the present disclosure proposes the following options D1-D3 for transmitting the PDU set type 2.
Option D1: the CU may route all the PDCP PDUs of the PDU set type 2 via the primary tunnel even though some PDCP PDUs of the PDU set type 2 may have been transmitted with the secondary tunnel.
Option D2: the CU may continue transmitting the remaining PDCP PDUs of the PDU set type 2 via the secondary tunnel and may start to route the next PDU set type 2 to the primary tunnel. In this case, the secondary tunnel may be deactivated after the transmission of the PDU set type 2.
Option D3: the CU may route the remaining PDCP PDUs of the PDU set type 2 to the primary tunnel.

In operation 816, the CU may perform the transmission of all PDU sets with the primary tunnel.

In some other embodiments, the CU may determine whether to activate or deactivate the secondary tunnel (e.g., the secondary F1-U tunnel). The CU may transmit the indication, such as the secondary LCH activation indication or the secondary LCH deactivation indication, to the DU. Then the CU may perform DL data transmission with both the primary tunnel and the secondary tunnel with the DU.

The indication may also include an identifier of a reference PDCP PDU or a reference PDU set.

In some embodiments, after receiving the indication, the DU may transmit the indication, such as the secondary LCH activation indication or the secondary LCH deactivation indication, to the UE, and may perform DL data transmission with the primary LCH (or primary leg) and the secondary LCH (or secondary leg) with the UE.

The indication may also include an identifier of a reference PDCP PDU or a reference PDU set.

FIG. 9 illustrates a method performed by a UE according to some embodiments of the present disclosure.

In operation 901, the UE may receive, via the transceiver, a secondary LCH activation indication from a BS for activating a secondary LCH of a DRB; and in operating 902, the UE may activate the secondary LCH of the DRB in response to receiving the secondary LCH activation indication from the BS; and in operating 903, the UE may route a PDCP PDU of a PDU set through the secondary LCH of the DRB upon activating the secondary LCH of the DRB.

In some embodiments, the secondary LCH activation indication is received by a MAC CE of the UE or a PDCP control PDU.

In some embodiments, the UE may receive a RRC message including at least one of the following: a second indication indicating whether the DRB is configured with a primary LCH and the secondary LCH; a third indication indicating whether an LCH is a primary LCH or a secondary LCH; an association between a type of a PDU set and an LCH; or a default activation or deactivation status of the secondary LCH. For example, in operation 301, the UE may receive the RRC message, an RRC configuration message.

In some embodiments, the association indicates that a type of PDU set with a second priority level (e.g., PDU set type 2) is to be associated with the secondary LCH, or indicates that a type of PDU set with a first priority level (e.g., PDU set type 1) and a type of PDU set with a second priority level (e.g., PDU set type 2) are to be both associated with a primary LCH and the secondary LCH, respectively.

In some embodiments, the UE may perform one of the following: in the case that a type of a first PDU set is with a first priority level (e.g., PDU set type 1), route all PDCP PDUs in the first PDU set to the primary LCH; and in the case that a type of a second PDU set is with a second priority level (e.g., PDU set type 2), wherein the second priority level has a lower priority level than the first priority level, route all PDCP PDUs in the second PDU set to the secondary LCH.

In some embodiments, in the case that there are remaining PDCP PDUs of a PDU set with a second priority level to be transmitted with a primary LCH, the processor is further configured to perform one of the following: route all PDCP PDUs of the PDU set with the second priority level (e.g., PDU set type 2) to the secondary LCH; route a next PDU set with the second priority level (e.g., PDU set type 2) to the secondary LCH; or route the remaining PDCP PDUs of the PDU set with the second priority level (e.g., PDU set type 2) to the secondary LCH.

In some embodiments, the UE may receive, via the transceiver, a secondary LCH deactivation indication from the BS for deactivating the secondary LCH of the DRB; and the UE may deactivate the secondary LCH of the DRB; and route PDCP PDU of the PDU set through the primary LCH in response to receiving the secondary LCH deactivation indication from the BS.

In some embodiments, the UE may receive, via the transceiver, a secondary LCH deactivation indication from the BS for deactivating the secondary LCH of the DRB, and there are remaining PDCP PDUs of a PDU set with a second priority level to be transmitted with a secondary LCH, and in response to receiving the secondary LCH deactivation indication from the BS, the UE may perform one of the following: route all PDCP PDUs of the PDU set with the second priority level to a primary LCH; route a next PDU set with the second priority level to the primary LCH; or route the remaining PDCP PDUs of the PDU set with the second priority level to the primary LCH.

In some embodiments, the secondary LCH activation indication includes an identifier of a reference PDCP PDU or an identifier of a reference PDU set, and the processor is further configured to: activate the secondary LCH upon transmission of the reference PDCP PDU or the reference PDU set.

In some embodiments, the secondary LCH deactivation indication includes an identifier of a reference PDCP PDU or an identifier of a reference PDU set, and the processor is further configured to: deactivate the secondary LCH upon transmission of the reference PDCP PDU or the reference PDU set.

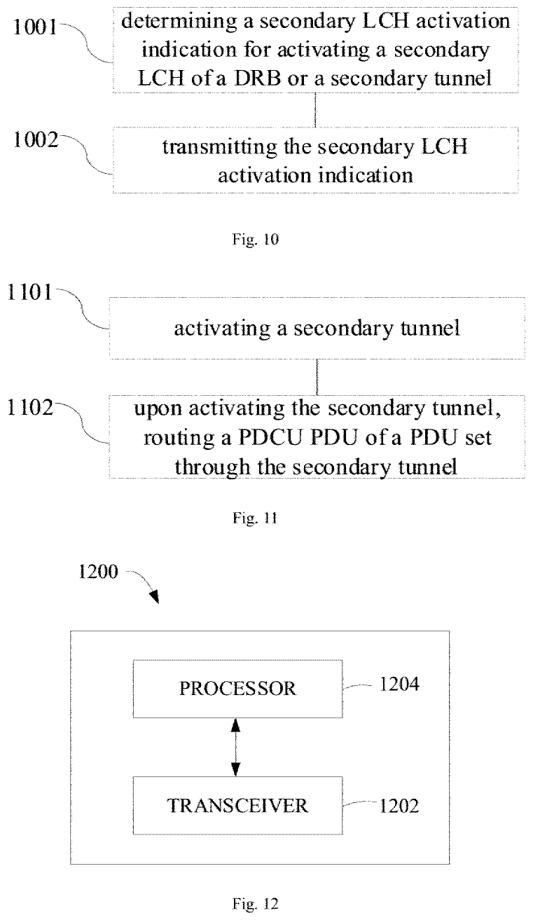

FIG. 10 illustrates a method performed by a DU according to some embodiments of the present disclosure.

In operation 1001, the DU may determine a secondary LCH activation indication for activating a secondary LCH of a DRB or a secondary tunnel; and in operation 1002, the DU may transmit, via the transceiver, the secondary LCH activation indication.

In some embodiments, the secondary LCH activation indication is transmitted to a UE, and is carried by a MAC CE or a PDCP control PDU. In some embodiments, the secondary LCH activation indication is transmitted to a CU, and is included in an F1 signalling or in an F1 user plane protocol.

In some embodiments, the DU may perform one of the following: determine a secondary LCH deactivation indication for deactivating a secondary LCH of the DRB or the secondary tunnel; and transmit, via the transceiver, the secondary LCH deactivation indication.

FIG. 11 illustrates a method performed by a CU according to some embodiments of the present disclosure.

In operation 1101, the CU may activate a secondary tunnel; and in operation 1102, the CU may route a PDCU PDU of a PDU set through the secondary tunnel upon activating the secondary tunnel.

In some embodiments, the CU may perform one of the following: in the case that a type of a first PDU set is with a first priority level, route all PDCP PDUs in the first PDU set to the primary tunnel; and in the case that a type of a second PDU set is with a second priority level, route all PDCP PDUs in the second PDU set to the secondary tunnel, wherein the second priority level has a lower priority level than the first priority level.

In some embodiments, in the case that there are remaining PDCP PDUs of a PDU set with a second priority level to be transmitted with a primary tunnel, the processor is further configured to perform one of the following: route all PDCP PDUs of the PDU set with the second priority level to the secondary tunnel; route a next PDU set with the second priority level to the secondary tunnel; or route the remaining PDCP PDUs of the PDU set with the second priority level to the secondary tunnel.

In some embodiments, the CU may deactivate the secondary tunnel; deactivate the secondary tunnel; and route a PDCP PDU of the PDU set through the primary tunnel in response to deactivating the secondary tunnel.

In some embodiments, the CU may deactivate the secondary tunnel, and in the case that there are remaining PDCP PDUs of a PDU set with a second priority level to be transmitted with the secondary tunnel; upon deactivating the secondary tunnel, to perform one of the following: route all PDCP PDUs of the PDU set with the second priority level to a primary tunnel; route a next PDU set with the second priority level to the primary tunnel; or route the remaining PDCP PDUs of the PDU set with the second priority level to the primary tunnel.

In some embodiments, an identifier of a reference PDCP PDU or an identifier of a reference PDU set is determined, and the CU may activate the secondary tunnel upon transmission of the reference PDCP PDU or the reference PDU set.

In some embodiments, an identifier of a reference PDCP PDU or an identifier of a reference PDU set is determined, and the CU may deactivate the secondary tunnel upon transmission of the reference PDCP PDU or the reference PDU set.

FIG. 12 illustrates a simplified block diagram of an apparatus according to some embodiments of the present disclosure.

As shown in FIG. 12, an example of the apparatus 1200 may include at least one processor 1204 and at least one transceiver 1202 coupled to the processor 1204. The apparatus 1200 may be a UE, a BS, a CU, a DU, or any other device with similar functions.

Although in this figure, elements such as the at least one transceiver 1202 and processor 1204 are described in the singular, the plural is contemplated unless a limitation to the singular is explicitly stated. In some embodiments of the present disclosure, the transceiver 1202 may be divided into two devices, such as a receiving circuitry and a transmitting circuitry. In some embodiments of the present disclosure, the apparatus 1200 may further include an input device, a memory, and/or other components.

In some embodiments of the present disclosure, the apparatus 1200 may be a UE, a CU, or a DU. The transceiver 1202 and the processor 1204 may interact with each other so as to perform the operations of the UE, the CU, or the DU described in any of FIGS. 1-11.

In some embodiments of the present disclosure, the apparatus 1200 may further include at least one non-transitory computer-readable medium.

For example, in some embodiments of the present disclosure, the non-transitory computer-readable medium may have stored thereon computer-executable instructions to cause the processor 1204 to implement the method with respect to the UE, the CU, or the DU as described above. For example, the computer-executable instructions, when executed, cause the processor 1204 interacting with transceiver 1202 to perform the operations of the UE, the CU, or the DU described in any of FIGS. 1-11.

In some embodiments of the present disclosure, the non-transitory computer-readable medium may have stored thereon computer-executable instructions to cause the processor 1204 to implement the method with respect to the node as described above. For example, the computer-executable instructions, when executed, cause the processor 1204 interacting with transceiver 1202 to perform the operations of the node described in any of FIGS. 1-11.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
receive a secondary logical channel (LCH) activation indication for activating a secondary LCH of a data radio bearer (DRB); and
in response to the secondary LCH activation indication:
activate the secondary LCH of the DRB; and
upon activating the secondary LCH of the DRB, route a packet data convergence protocol (PDCP) protocol data unit (PDU) of a PDU set through the secondary LCH of the DRB.

2. The UE of claim 1, wherein the secondary LCH activation indication is received by a medium access control control element (MAC CE) of the UE or a PDCP control PDU.

3. The UE of claim 1, wherein the at least one processor is further configured to cause the UE to:
receive a radio resource control (RRC) message including at least one of:
a second indication that indicates whether the DRB is configured with a primary LCH and the secondary LCH;
a third indication that indicates whether an LCH is a primary LCH or the secondary LCH;
an association between a type of the PDU set and an LCH; or
a default activation or deactivation status of the secondary LCH.

4. The UE of claim 1, wherein the at least one processor is further configured to cause the UE to perform one of:
in a case that a type of a first PDU set is with a first priority level, route all PDCP PDUs in the first PDU set to a primary LCH; and
in a case that a type of a second PDU set is with a second priority level, wherein the second priority level has a lower priority level than the first priority level, route all PDCP PDUs in the second PDU set to the secondary LCH.

5. The UE of claim 1, wherein in a case that there are remaining PDCP PDUs of a PDU set with a second priority level to be transmitted with a primary LCH, the at least one processor is further configured to cause the UE to perform one of:
route all PDCP PDUs of the PDU set with the second priority level to the secondary LCH;
route a next PDU set with the second priority level to the secondary LCH; or
route the remaining PDCP PDUs of the PDU set with the second priority level to the secondary LCH.

6. The UE of claim 1, wherein the at least one processor is further configured to cause the UE to:
receive a secondary LCH deactivation indication for deactivating the secondary LCH of the DRB; and
in response to the secondary LCH deactivation indication, deactivate the secondary LCH of the DRB; and
route the PDCP PDU of the PDU set through a primary LCH.

7. The UE of claim 1, wherein the at least one processor is further configured to cause the UE to:
receive a secondary LCH deactivation indication for deactivating the secondary LCH of the DRB, and there are remaining PDCP PDUs of the PDU set with a second priority level to be transmitted with a secondary LCH; and
in response to the secondary LCH deactivation indication, perform one of:
route all PDCP PDUs of the PDU set with the second priority level to a primary LCH;
route a next PDU set with the second priority level to a primary LCH; or
route the remaining PDCP PDUs of the PDU set with the second priority level to the primary LCH.

8. The UE of claim 6, wherein the secondary LCH deactivation indication includes an identifier of a reference PDCP PDU or an identifier of a reference PDU set, and the at least one processor is further configured to cause the UE to:
deactivate the secondary LCH upon transmission of the reference PDCP PDU or the reference PDU set.

9. A distributed unit (DU) for wireless communication, comprising:
at least one memory; and
at least one processor coupled with the at least one memory and configured to cause the DU to:
determine a secondary logical channel (LCH) activation indication for activating a secondary LCH of a data radio bearer (DRB) or a secondary tunnel; and
transmit the secondary LCH activation indication.

10. The DU of claim 9, wherein the secondary LCH activation indication is transmitted by a medium access control control element (MAC CE) or a PDCP control PDU.

11. The DU of claim 9, wherein the secondary LCH activation indication is included in an F1 signaling or in an F1 user plane protocol.

12. The DU of claim 9, wherein the at least one processor is further configured to cause the DU to perform one of:
determine a secondary LCH deactivation indication for deactivating the secondary LCH of the DRB or the secondary tunnel; and
transmit the secondary LCH deactivation indication.

13. A central unit (CU) for wireless communication, comprising:
at least one memory; and
at least one processor coupled with the at least one memory and configured to cause the CU to:
activate a secondary tunnel; and
upon activating the secondary tunnel, route a packet data convergence protocol (PDCP) protocol data unit (PDU) of a PDU set through the secondary tunnel.

14. The CU of claim 13, wherein in a case that there are remaining PDCP PDUs of a PDU set with a second priority level to be transmitted with a primary tunnel, the at least one processor is further configured to cause the CU to perform one of:
route all PDCP PDUs of the PDU set with the second priority level to the secondary tunnel;
route a next PDU set with the second priority level to the secondary tunnel; or
route the remaining PDCP PDUs of the PDU set with the second priority level to the secondary tunnel.

15. The CU of claim 13, wherein the at least one processor is further configured to cause the CU to:
deactivate the secondary tunnel, and in a case that there are remaining PDCP PDUs of a PDU set with a second priority level to be transmitted with the secondary tunnel;
upon deactivating the secondary tunnel, to perform one of:
route all PDCP PDUs of the PDU set with the second priority level to a primary tunnel;
route a next PDU set with the second priority level to the primary tunnel; or
route the remaining PDCP PDUs of the PDU set with the second priority level to the primary tunnel.

16. A method performed by a user equipment (UE), the method comprising:
receiving a secondary logical channel (LCH) activation indication for activating a secondary LCH of a data radio bearer (DRB); and
in response to receiving the secondary LCH activation indication:
activating the secondary LCH of the DRB; and
upon activating the secondary LCH of the DRB, routing a packet data convergence protocol (PDCP) protocol data unit (PDU) of a PDU set through the secondary LCH of the DRB.

17. The method of claim 16, wherein the secondary LCH activation indication is received by a medium access control control element (MAC CE) of the UE or a PDCP control PDU.

18. The method of claim 16, further comprising:
receiving a radio resource control (RRC) message including at least one of:
a second indication that indicates whether the DRB is configured with a primary LCH and the secondary LCH;
a third indication that indicates whether an LCH is a primary LCH or the secondary LCH;
an association between a type of the PDU set and an LCH; or
a default activation or deactivation status of the secondary LCH.

19. The method of claim 16, further comprising:
in a case that a type of a first PDU set is with a first priority level, route all PDCP PDUs in the first PDU set to a primary LCH; and
in a case that a type of a second PDU set is with a second priority level, wherein the second priority level has a lower priority level than the first priority level, route all PDCP PDUs in the second PDU set to the secondary LCH.

20. The method of claim 16, wherein in case that there are remaining PDCP PDUs of a PDU set with a second priority level to be transmitted with a primary LCH, the method further comprising:
routing all PDCP PDUs of the PDU set with the second priority level to the secondary LCH;
routing a next PDU set with the second priority level to the secondary LCH; or
routing the remaining PDCP PDUs of the PDU set with the second priority level to the secondary LCH.
